(19) United States
(12) Patent Application Publication
(10) Pub. No.: US 2025/0242843 A1
(43) Pub. Date: Jul. 31, 2025

(54) Systems and Methods for Intelligent Fault-in-Rail Analysis

(71) Applicant: Transit Pro Tech. Limited, Wan Chai (HK)

(72) Inventors: Weihong Du, Shenzhen (CN); Weihang Wei, Shenzhen (CN)

(21) Appl. No.: 18/823,082

(22) Filed: Sep. 3, 2024

Related U.S. Application Data
(60) Provisional application No. 63/624,812, filed on Jan. 25, 2024.

(51) Int. Cl. B61L 23/04; G06F 18/25; G06N 20/00

(52) U.S. Cl. CPC B61L 23/042; G06F 18/251; G06N 20/00

(57) ABSTRACT

An intelligent fault-in-rail analysis method based on multimodal fusion learning. Ultrasonic analysis data of the rail and high-definition rail surface images taken by line scan cameras are exploited in combination to detect and display internal and surface faults of the rail through different renditions using multimodal data. Rail DEtection TRansformer (R-DETR) technology or a You Only Look Once (YOLO) inspection machine-learning algorithm are employed in a deep convolutional neural network to analyze B-scan and rail surface image data to recognize rail line faults. After obtaining expressive data through data enhancement by computer processing, faults are recognized and pinpointed using the deep convolutional neural network learning algorithm. Analysis results are corrected with expert systems. The disclosed automatic ultrasonic fault-in-rail inspection solves the problem of slow detection and difficulties in tracking faults in everyday routine maintenance while also protecting the safety of rail operation and maintenance personnel.

### RELATED APPLICATION

This application claims priority to U.S. Provisional Application No. 63/624,812, filed Jan. 25, 2024, which is incorporated herein by reference.

### FIELD OF THE INVENTION

The present invention relates generally to railway systems. More particularly, disclosed herein are systems and methods for fault detection and analysis of railway tracks.

### BACKGROUND OF THE INVENTION

Railway systems are ubiquitous worldwide. Millions of people travel by commuter trains and subways on railway lines every day. Railway lines are also used in commercial freight and long-distance passenger transport systems. Such railway lines are required to be both safe and reliable. One source of unreliability and jeopardy is damage to the railway lines on which the train cars travel. Now and historically, significant resources have been dedicated to ensuring that the metal railway lines on which the cars operate are in good working order so that the transport networks are safe and reliable. This is typically accomplished through fault-in-rail analysis and detection techniques, which include visual inspection of railway lines with cameras as well as certain rail integrity testing using certain sonic detection apparatus. Such techniques may be deployed on rail inspection vehicles which periodically traverse rail networks searching for faults.

Because of their wide scope of detection, high sensitivity, and time effectiveness, large scale fault-in-rail inspection vehicles are currently used globally in everyday, routine fault detection operations. However, the technology used in fault inspection and recognition in most areas is still relatively outdated and suffers from many limitations. For example, current fault inspection reports are commonly generated by fault inspection personnel who play back and check, frame by frame, the image data, often referred to herein as B-scan image data, obtained from the ultrasonic sampling signals of the rails. These personnel manually scan the inspection records along a certain length of rails, find the apparent faults, and report the results. The results are reviewed, and the rail is repaired based on this analysis. This model of operation is inefficient due to its imprecision and labor-intensive nature. It is also unreliable because the results are subject to human error. Thus, the probability of missed faults is high and poses an undesirable threat to the safe, reliable, and economically efficient operation of the rail system.

### SUMMARY OF THE INVENTION

To address these and other shortcomings, one aspect of the intelligent fault-in-rail system uses an intelligent fault-in-rail analysis method based on what can be referred to as multimodal fusion of collected data. This aspect of the system and method is concerned with fault detection analysis in railway systems that includes the use of both visual and other available data that may pre-exist or be acquired as needed to complete the desired analysis. This may include visual data acquired through optical means or that may pre-exist and is acquired as needed to complete the desired analysis. Other data may include ultrasonic or other vibration-based data. In some embodiments, the system and method may employ multimodal data, obtained through ultrasonic or other means, to analyze both potential internal and external faults such as undesirable fractures, stresses, plastic deformation, and potentially other internal or external faults. In one specific embodiment, aspects of the system and method may comprehensively analyze “all-around” faults in the fault-in-rail inspection scenarios to achieve high precision. This may include automatic positioning and recognition of the faults. The system and method may combine visual recognition with data processing of multiple other formats of data and may perform an all-around fault inspection operation to detect both the internal and surface faults of rails.

This novel approach may acquire, combine, and/or otherwise jointly process ultrasonic fault detection signal data obtained by conventional means with rail surface image data captured by high-definition cameras to conduct the analysis. Optically acquired data of the rails may serve as a starting point in the analysis. For example, B-scan image data and rail surface image data captured by high-definition cameras are enhanced to increase the reliability of the data distribution. It then may use reliable object detection technology, such as Rail DEtection TRansformer (R-DETR) technology, on the B-scan and rail surface image data to recognize faults. This generally may be accomplished through pattern matching, threshold comparison, algorithmic analysis, artificial intelligence (AI), or other methods as will be further described below.

For example, B-scan ultrasonic image recognition data may be used to pinpoint potential fault candidates. Once the specific location is determined, the rail surface faults that may cause damage to the rails are confirmed with reference to high-definition optical rail surface image data. In some embodiments, where faults are difficult to recognize by object detection technology, other criteria and additional data, such as sonic testing, may be used to confirm and categorize them. Moreover, further processing, such as expert system rules, may be applied. The fault inspection and judgment logic in actual fault inspection operation are quantified to achieve desired fault detection goals. Fault detection results may also be optimized using the statistical and time-frequency characteristics of ultrasonic echo signals after which a final fault inspection report may be generated.

Thus, an intelligent fault-in-rail analysis method based on multimodal fusion learning is provided. In one embodiment, on the basis of ultrasonic analysis data of the rail, combining with high-definition rail surface images taken by line scan cameras, the method may display both internal and surface faults of the rail through different renditions using multimodal data. After obtaining more expressive data through data enhancement by computer processing, it recognizes and pinpoints the faults using the deep convolutional neural network (CNN) learning algorithm and, with the help from expert systems, the analysis results are corrected. Not only does automatic ultrasonic fault-in-rail inspection solve the problem of slow detection and difficulties in tracking the faults in everyday routine maintenance, but also protects the safety of the operation and maintenance personnel of the rail system.

Certain embodiments of the invention may thus be characterized as a method for fault-in-rail analysis based on multimodal data to determine rail line faults. The method can comprise acquiring optical images of a rail surface to produce optical rail data and acquiring sonic based rail data. Image data of the rail is electronically computed from the acquired sonic based rail data, and the optical rail data and the sonic based rail data are correlated. Finally, the optical rail data and the sonic based rail data are used to determine the rail line faults, such as through an expert system.

In practices of the invention, sonic based rail data can be preprocessed, and detected rail line faults can be classified. Furthermore, as taught herein, rail line faults can in certain embodiments of the invention be detected by use of an R-DETR or YOLO inspection algorithm.

In other embodiments, the invention may be characterized as a system for fault-in-rail analysis based on multimodal data to determine rail line faults. The system can include a first sensor for acquiring optical images of a rail surface of a rail line to produce optical rail data and a second sensor for acquiring sonic based rail data. An electronic computing apparatus, which may comprise a single computer or computer processor or plural computers or computer processors acting in combination, is provided for computing image data of the rail from the acquired sonic based rail data. The computing apparatus is operative to correlate the optical rail data and the sonic based rail data, and the computing apparatus is further operative to use the optical rail data and the sonic based rail data to determine rail line faults.

One will appreciate that the foregoing discussion broadly outlines certain goals and features of non-limiting embodiments of the invention to enable a better understanding of the detailed description that follows and to instill a better appreciation of the inventors' contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

Other characteristics and advantages of the system and method disclosed herein will become apparent on reading the detailed description that follows with further reference to the accompanying drawings wherein like numbers are used to indicate like components and wherein:

FIG. 1 is a block diagram of an embodiment of the system for intelligent fault-in-rail analysis disclosed herein;

FIG. 2 is a block diagram of an image recognition system in accordance with an embodiment of the system for intelligent fault-in-rail analysis;

FIG. 3 is a block diagram of the transformer structure;

FIG. 4 is a block diagram of a convolutional neural network (CNN) that may be used for image classification in accordance with the present invention;

FIG. 5 is a graph of a rail head echo signal visualized using sonic based data;

FIG. 6 is the graph illustrating noise envelopments that may be associated with data acquisition; and

FIG. 7 is a graphical representation of echo waves of normal and abnormal welding seams.

### DETAILED DESCRIPTION OF PREFERRED EMBODIMENTS

The systems and methods for intelligent fault-in-rail analysis disclosed herein are subject to a wide variety of embodiments within the scope of the invention. However, to ensure that one skilled in the art will be able to understand and, in appropriate cases, practice the present invention, certain preferred embodiments of the systems and methods are described below with reference to the accompanying drawing figures.

Practices of the present invention provide an overall framework for intelligent fault-in-rail analysis based on the use of multiple data types in what is referred to herein as multimodal-fusion and typically includes the enhancement and/or preprocessing of the B-scan ultrasonic image data and high-definition rail surface image data, the positioning and recognition of faults using B-scan ultrasonic image data, the positioning and recognition of anomalies using the high-definition rail surface image data, sonic analysis of the recognized faults, specific fine-grained classification, location synchronization, and post-processing by the expert system.

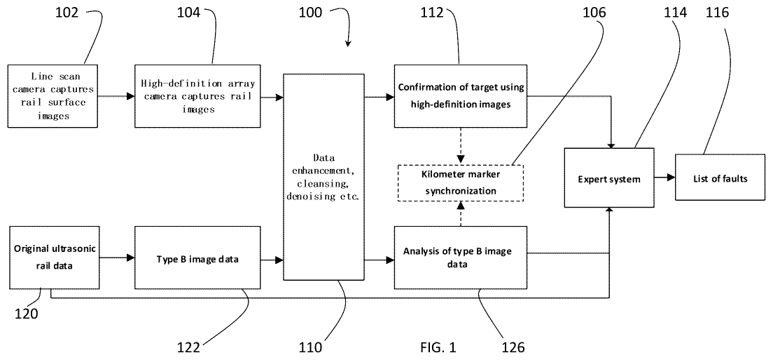

An embodiment of the system for intelligent fault-in-rail analysis is indicated generally at 100 in the block diagram of FIG. 1. Referencing the diagram of FIG. 1 from left to right, a fault inspection vehicle operating according to the present invention traversing a section of a rail may capture rail surface images using a line scan camera 102 and may also capture ultrasonic rail data 120 either concurrently or at some other point in time. Next, high-definition cameras 104 capture rail image data, and the ultrasonic data 120 is converted into B-scan image data 122. The B-scan image data 122 and the high-definition visual image data may then be enhanced using known data enhancement signal processing methods 110, such as but not limited to noise filtering, amplification, to optimize data quality.

The visual image data and the B-scan ultrasonic image data 122 are analyzed and synchronized in an analysis of B-scan image data 126 and synchronization 106 to a specific location on the rail to ensure both data points relate to exactly the same portion of the rail in a confirmation of target 112. Both types of data, namely visual image data and the B-scan ultrasonic image data 122, are analyzed by an expert system 114 in a multimodal format. The system for intelligent fault-in-rail analysis 100 recognizes and pinpoints faults in the rail using analytical systems which, in preferred embodiments, include the deep convolutional neural network (CNN) learning algorithm. With the help from the expert system 114, the analysis results are corrected. The output of the system 100 is a list of detected faults 116 that are based on both data types and, therefore, have increased accuracy in both detection and classification of the faults. It should be appreciated that, not only does the automatic ultrasonic fault-in-rail inspection solve the problem of slow detection and difficulties in tracking the faults in everyday routine maintenance, but it also protects the safety of the operation and maintenance personnel of the rail system.

Multimodal Data. Multimodal data as used herein refer to data obtained from different sources, such as but not limited to different sensors, of different categories and in different formats, such as images, sound, text documents, sensor data, and potentially other categories and formats. These data may have their own structures, characteristics, dimensionalities, and expressions, but usually involve the same event, same object, and same task and thus need to be analyzed and processed together to provide the improved precision contemplated by the present invention.

The multimodal data may, in accordance with one aspect of an embodiment of the invention as shown in FIG. 1, include ultrasonic echo signals from fault detection, B-scan image data 122, and high-definition rail surface images captured by line scan cameras. Sensors and hardware for these data including ultrasonic echo signals, B-scan image data 122, and high-definition rail surface image data. Such types of modal data can be deployed on conventional fault detection vehicles. These data have their own advantages and characteristics respectively as referenced herein. However, in prior art systems, such data is not used in the multimodal fashion described herein and is slower and less accurate than the results obtained by the present invention.

Because of their high sensitivity, speed and wide scope of detection, large-scale fault detection vehicles (not shown) are widely used in fault-in-rail detection operations. The internal faults-in-rail can be detected because the ultrasonic wave reflects when there is a change in medium, such as but not limited to a change in the density of the rail material. In accordance with the present invention, multiple sensors that emit ultrasonic signals are deployed at various angles on the inspection vehicle, pointing in different directions to obtain a comprehensive spectrum of reflected signals, and thereby robustly detect faults. The ultrasonic echo signals collected may include pulse position, depth position, names of detection channel, and other signals. Any suitable data set of echoes may be collected if desired to achieve certain detection goals as is known in the art. Because these signals are emitted and collected along the time axis, the original ultrasonic signal can be processed as a time series signal in the system for intelligent fault-in-rail analysis 100.

Based on the ultrasonic data of the rail, B-scan image data 122 is visualization data drawn at predetermined positions, potentially using existing standard legends designed in the industry and the information on pulse position, depth position, names of the detection channels, and other details. It visualizes the abstract time series data so that inspection personnel can directly observe the status of the data based on the shape and density of the echo signal and analyze the faults inside the rail. It is currently common practice in the industry to play back the B-scan image frame by frame in fault detection operations.

High-definition rail surface images captured by line scan cameras installed underneath the large-scale fault detection vehicles are collected while the vehicle moves along the rail. Unlike B-scan image data resulting from logical imaging through one-time processing, high-definition rail surface images directly show the rail after real world operations. They serve as an important guidance for surface faults and some severe faults.

Data Preprocessing. In accordance with a preferred embodiment of the invention, data of different modalities may be preprocessed to achieve testing analysis goals. For example, when using ultrasonic echo waves, high-level information of the data may be incomplete or difficult to obtain. By preprocessing this information, high level correlation and trends can be determined. This is discussed mainly in the expert system portion of the disclosure hereinbelow with the operations for the preprocessing of the B-scan and high-definition rail surface image data being the focus.

The actual preprocessing steps are as follows. In accordance with one aspect of the invention, the preprocessing of the B-scan image data 122 and the high-definition rail surface image data are drawn according to positions and a predefined legend based on the ultrasonic echo signal. The size of the B-scan image data 122 is limited. A sliding window of predetermined pulse length, such as 960 pulses by way of non-limiting example, is used on ultrasonic echo signal data of the entire rail to draw the image data 122.

When “cleaning” or “clarifying” the B-scan image data 122 during data enhancement 110, the system 100 may advantageously filter out certain unhelpful data, such as the information provided by the bottom wave disappearance signal. The reason for this is that such information is typically only used for supplementary inspection and thus lacks real physical importance. To eliminate its interference to fault judgment, the system 100 hides the bottom wave disappearance signal when drawing the B-scan image data 122. Enhancement of the B-scan image data 122 may involve known conventional image enhancement techniques such as data flipping, cropping, and mosaic. In addition, there are usually few faults in the B-scan image data 122 collected in actual fault detection operation. According to the present invention, the system 100 uses the specific target filling method for data augmentation to increase the amount of fault data to improve the expressiveness of it, including by minimizing and/or filtering out noise and unrelated signal information to improve the quality of the data and thereby improve fault detection.

As for the high-definition rail surface image data, abnormalities due to an irregular natural lighting environment may introduce noise and other data anomalies caused by interference. Thus, in some embodiments of the invention, adaptive brightness correction is used to perform brightness correction on image data acquired with different ambient light conditions. For example, a Gaussian filter can be used to eliminate noise such as what can be referred to as “salt-and-pepper noise” and other noise in the image data.

Analysis of the B-scan Image Data. Compared with classical DETR, R-DETR is a known end-to-end target inspection and classification model, where “R” stands for “Rail” and “DETR” stands for “DEtection TRansformer.” In comparison with conventional DETR, R-DETR uses a lighter basis network and adjusts the feed forward network (FFN) module in the Transformer structure to speed up computation and decrease model size. One of ordinary skill in the relevant art would be aware of and would understand the R-DETR end-to-end target inspection and classification model. For additional understanding, the concept is further discussed in Zhu X, Su W, Lu L, et al. Deformable DETR: Deformable Transformers for End-to-End Object Detection[J]. 2020.DOI: 10.48550/arXiv.2010.04159, which is incorporated by reference in its entirety.

In the meantime, the system 100 uses a Feature Pyramid Transformer Network (“FPN”) to improve inspection accuracy on small targets. One of ordinary skill in the art would be aware of and would understand such an FPN, and the concept is further discussed in Lin T Y, Dollar P, Girshick R, et al. Feature Pyramid Networks for Object Detection[J]. IEEE Computer Society, 2017.DOI: 10.1109/CVPR.2017.106, which is incorporated by reference in its entirety.

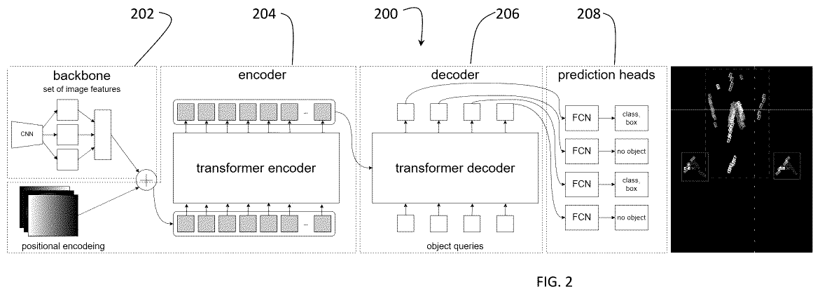

The R-DETR adjusts both the network structure and the FFN module to realize faster computation and smaller model size. An image recognition system according to the present invention is indicated at 200 in FIG. 2. The system FFN module in the Transformer structure shown in the image recognition system 200 of FIG. 2 generally relates to the contents of the analysis of B-scan image data block 126 in FIG. 1.

There, the target positioning and initial classification process of the R-DETR image recognition may be performed in the following steps. First, three types of feature maps of different sizes are obtained from the object detection system. One suitable object detection system is the Darknet-53 backbone. Darknet-53 is a convolutional neural network that acts as a backbone 202 for the YOLOv3 (You Only Look Once, Version 3) object detection approach. YOLOv3 is a real-time object detection algorithm that identifies specific objects in videos, live feeds, or images. The YOLO machine-learning algorithm uses features learned by a deep convolutional neural network to detect an object. While the YOLO machine-learning algorithm is presently preferred, it will be understood that any other suitable object detection system may be used if desired within the scope of the invention.

Once obtained, acquired objection detection data may be transformed and merged into sequence data through channel and spatial dimension compression. The transformed and merged data is combined with position encoding, and each of the feature maps is sent into the transformer encoder 204. At this point, the transformer encoder 204 performs the computation. In one suitable but non-limiting embodiment, the transformer encoder 204 includes six Multi-Head Self-Attention modules and a feed-forward convolutional network (FCN) module consisting of three convolutional layers with 1*16 kernel and a Parametric Rectified Linear Unit (PRELU) that generalizes the traditional rectified unit with a slope for negative values n. Similarly, the decoder 206 may have object queries as learnable position encoding as its input, and the decoder 206 may also include six Multi-Head Self-Attention modules and a feed-forward convolutional network (FCN) module 208. The output is sent into FCNs for class of object and bounding box border inference and are classified in module 208, such as by classification as object, no object, and/or otherwise as further discussed below.

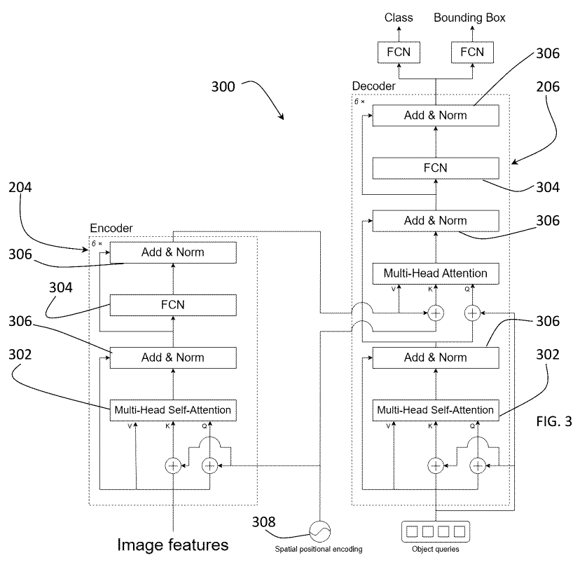

A block diagram of the transformer structure is indicated generally at 300 in FIG. 3, and a further understanding of the transformer encoder 204 and the decoder structure 206 can be had by combined reference to FIGS. 2 and 3.

The input aspect of the transformer structure 300: After the add operation on the image features and the spatial positional codes corresponding to the spatial positional encoding 308 in FIG. 3 from the backbone 202, the results are sent into the transformer encoder 204 as its input. In the end, inspection of the targets is confirmed using the positions of the targets in the obtained images. Spatial positional encoding 308 is, in fact, encoding the positional information of the pixels or image patches. It provides the features on the context-like information of the images.

The transformer encoder 204: There is a stack of N encoders with 6 being illustrated in the manifestation of FIGS. 2 and 3. As in FIG. 3, every encoder 204 contains a multi-head self-attention module 302 whose inputs are the value V, key K, and query Q vectors.

The key vector K: The key vector K is a linear transformation of the input feature vectors. It contains important information about the input data. In the computing mechanism of self-attention, the key vectors K are used to compute the similarity between the current focus point (q) and every key vector K in the input data.

The query vector Q: The query vector Q is a linear transformation of the current position to be inspected. It has the same dimensionality as the key vector K. In the computing mechanism of self-attention 302, the query vector Q is used to compute the similarity between the current focus point (q) and every key vector K in the input data.

The value vector V: The value vector V is a linear transformation that is used to compute the weight of each self-attention. It has the same dimensionality as that of the key and query vectors K and Q. In the computing mechanism of self-attention 302, the system 100 uses the value vector V to compute the weights of self-attention and the corresponding weighted sum.

After the output features of the multi-head self-attention module 302 are obtained, add and norm 306 are performed on them and the image features to obtain global information and determine the important parts in the images. The output of this is passed through a feed-forward fully connected network (FCN) 304 for a nonlinear transformation. After another add and norm operation 306, the output features of the encoder 204 are generated.

The transformer decoder 206: There is also a stack of N decoders with 6 being illustrated in the manifestation of FIGS. 2 and 3. As a part of the input to the decoder 206, the object queries are learnable features that are completely independent of the images. They are mainly used to inquire and pinpoint target objects. Descriptors of the target queries are generated after passing the queries through a self-attention module 302 and add and norm operation 306. The final feature description of the target inspection is generated after combining the afore-mentioned descriptor with the encoder output and spatial positioning encoding 308, another FCN 304 and add and norm operation 306.

The output part of the transformer 300: The information on the inspected target is generated after passing the feature descriptions from the decoder output through two FCNs 304 for classification and bounding box inference, respectively.

The entire workflow of the transformer 300 is equivalent to the encoder-decoder operation. It has the advantage of automatic inspection of the position, size, and class of the targets based on the global description of the images, eliminating inspection errors caused by the sizes of the manually designed anchor points in traditional inspection algorithms.

In certain embodiments, there are four parts in the transformer framework: Input, Output, Encoder 204, and Decoder 206. The Input part includes a feature map and its spatial position encoder 308 and a target series and its spatial position encoder 308. The output part consists of two FCN structures 304 for the purpose of regression on the target bounding box and classification, respectively.

The encoder 204 consists of a stack of N encoder layers. Every encoder layer can consist of two sub-layers. The first sub-layer includes a multi-head self-attention layer, a normalization layer and a residual connection. The second sub-layer includes a feed-forward fully connected sub-layer, a normalization layer and a residual connection.

The decoder 206 consists of a stack of N decoder layers. Every decoder layer can consist of three sub-layers. The first sub-layer includes a multi-head self-attention layer, a normalization layer, and a residual connection. The second sub-layer includes a multi-head self-attention layer, a normalization layer, and a residual connection. The third sub-layer includes a feed forward fully connected sub-layer, a normalization layer, and a residual connection. The work flow of the transformer 300 is an encoder-decoder operation.

Rail-CNN Fine-grained Classification. A convolutional neural network (CNN) is commonly used for image classification, while an R-CNN, with the R standing for region, is for object detection. A typical CNN can only tell us the class of the objects but not where they are located. Instead of classifying every region using a sliding window, the R-CNN detector only processes those regions that are likely to contain an object. This greatly reduces the computational cost incurred when running a CNN. The R-CNN object detection method returns the object bounding boxes, a detection score, and a class label for each detection. The labels are useful when detecting objects of similar appearances.

The Rail-CNN carries out classification of objects with similar appearances, such as screw holes, welding seams, and joints. Further background may be found in Fu J, Zheng H, Mei T. Look Closer to See Better: Recurrent Attention Convolutional Neural Network for Fine-Grained Image Recognition[C]//IEEE Conference on Computer Vision & Pattern Recognition. IEEE, 2017.DOI: 10.1109/CVPR.2017.476, which is incorporated by reference in its entirety.

Unlike traditional image classification, fine-grained fault classification is intended to recognize the detailed features of the targets. For example, the number of points and shape of the output waves of identical objects differ only slightly. Since the output waves of screw holes, welding seams, and joints have symmetrical structure, it is recognized that there is a high probability of either incomplete output waves or faults if the output waves show asymmetry. When this happens, other modal data can be used to confirm.

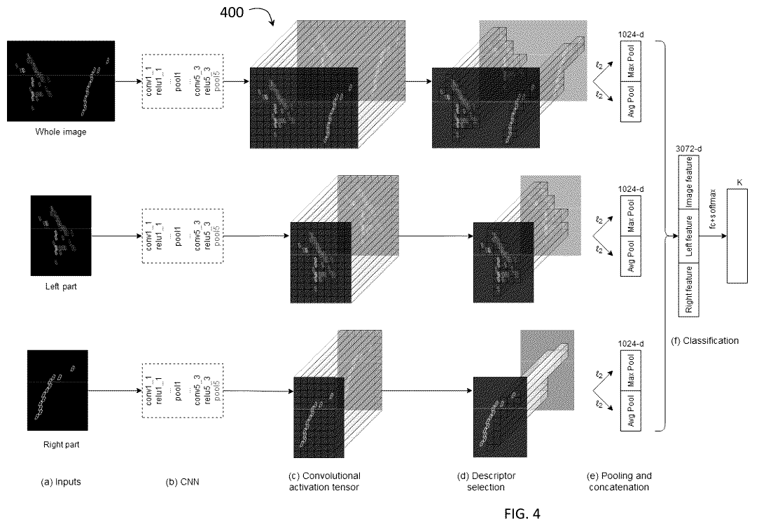

In one embodiment, the Rail-CNN model of the present invention may be designed for targets that have symmetrical structures. Part annotations and image labels are needed in training. Part annotations can be divided into two sets: left-half labels and right-half labels. A Rail-CNN model is indicated generally at 400 in FIG. 4. In this embodiment, the Rail-CNN model 400 is a three-stream model with three inputs comprising the whole image, the left part of the image, and the right part of the image. It is noted, however, that other inputs may be used as desired so long as data representing the whole surface of interest is acquired. In the processing threads for the whole image, the left part of the image, and the right part of the image, deep descriptors are selected and obtained after convolution through the convolutional neural network (CNN) with a convolutional activation tensor, and three 1024-dimensional vectors are thereafter generated. These vectors may then be concatenated into a 3072-dimensional vector. After a regression analysis, such as but not limited to L2 regularization, and a fully connected network layer, classification may be made using the softmax function, such as but again not limited to a vector z of K real numbers, normalized into a probability distribution consisting of K probabilities.

Fault recognition With Rail Surface Images. High-definition rail surface images obtained for the system 100 are a type of rail surface images captured by an array of high-definition cameras installed on specialized vehicles. Image data thus obtained are transferred to mainframe computers for processing and analysis. High-definition rail surface images and ultrasonic fault detection signals are two different types of data. They have multiple notable differences.

Different purposes. High-definition rail surface image data are used for the inspection of surface faults and damages, such as rail surface cracks, fatigue cracks, stripping, rail surface light strips, and corrugation so that the rail can be repaired in a timely manner. Ultrasonic fault detection signals are mainly employed in the inspection of internal faults in the rail, such as cracks, internal slag inclusion, and other internal faults so that the safety and life expectancy of the rail can be evaluated.

Different data acquisition methods. Optical data comprising high-definition rail surface images are typically captured using optical devices aimed at the rail surface. Ultrasonic fault detection signals, however, are obtained using ultrasonic probes that scan the interior of the rail. Known signal processing and analysis techniques are used to detect faults, damages, and/or other irregularities, such as stress.

Different scope and depth of the faults. The faults inspected by the high-definition rail surface images have depth no greater than a few millimeters. Faults detected by ultrasonic fault detection signals, however, can reach more than 100 millimeters in depth. According to the present invention, cracks and faults, such as surface cracks, fatigue cracks, stripping, surface light strips, corrugations, and other faults on the rail surface are inspected using a target inspection method based on deep learning.

In accordance with an embodiment of the invention, the YOLOv5 algorithm may be used for target inspection. In this regard, a further understanding may be obtained by reference to Wu T H, Wang T W, Liu Y Q. Real-time vehicle and distance detection based on improved yolo v5 network[C]//2021 3rd World Symposium on Artificial Intelligence (WSAI). IEEE, 2021: 24-28, which is hereby incorporated by reference in its entirety. The backbone of the model is v5x. Images of size 512*512 are used as inputs. The construction of the model in accordance with one particular embodiment is shown as follows.

Preparation of Rail Surface Image Data. Based on the collected image data, images showing surface cracks, fatigue cracks, stripping, surface light strips, and corrugations can be manually or potentially automatically selected, preferably while ensuring that there are at least a predetermined number of images, such as but not necessarily 1500 images, in each category. The targets in these images are then manually or perhaps automatically boxed out and labeled using the image-labeling tool of the present invention. The data set may be divided into a training set and a test set, such as by use of an 8:2 ratio.

Training and Test of the Network Model. Parameters of the backbone CNN model 400 are initialized using parameters obtained from training with the coco data set. The fully connected layer is initialized using Gaussian random variables of 0 mean and standard deviation 0.1. The weights may be trained using the Adam gradient descent algorithm, and the learning rate can be initially set to 0.001 and to decrease by 10% after every 300 iterations.

Batch size can be set at 8. According to practices of the invention, the model is trained for 1000 iterations and is validated after every 10 iterations. The best performing model is saved as the result of the training process and is tested on the test set.

To pinpoint and inspect the targets, a combination of R-DETR and fine-grained classification is used on the B-scan image data 122, and the YOLO model is used on the high-definition rail surface image data. There are two reasons for this. The B-scan image data 122 are drawn according to predefined legend and channel information from the original ultrasonic echo signals. Because the data is already processed, prior knowledge is needed to analyze faults accurately. In addition, noise affects the data more since, similar to real targets, it is also an echo wave. Because the combination of R-DETR and fine-grained classification describes the image features using encoder-decoder pairs, it fits the abstract nature of the B-scan image data 122. On the other hand, high-definition rail surface image data, which have obvious features that are hard to mix with noise, can be observed directly.

Because of the size of the predefined legend, there are no small targets in the B-scan image data 122. R-DETR is good at inspecting large-scale targets, such as fatigue cracks, on the rail surface. Because the high-definition rail surface images are captured directly from the rails, they may show small dents and holes on the rail surface. Because they contain more small targets, YOLO inspection with an anchor free mechanism is a more appropriate fit for application to the high-definition rail surface images.

Synchronization of Location Markers. To provide context, the B-scan ultrasonic image data 122 drawn according to the pulse positions and high-definition rail surface image data are appended with location information, such as mile, kilometer, or other distance marker information. However, when these data are processed by deep learning neural networks, no distance marker information is needed. Thus, synchronization of the location information of the B-scan image data 122 and high-definition rail surface image data is necessary.

B-scan image data 122 are mainly used to inspect internal faults. It may happen that, when the sensor sensitivity is set too low, too few echo waves are received for the severity of a major fault to be properly shown. High-definition rail surface image data, on the other hand, mainly presents surface faults and targets, such as welding seams and joints, but shows nothing about internal aspects of the rail. Thus, synchronizing the location information of the two types of data can, first, eliminate the situation of major faults that could cause broken rails being missed due to single data only and, second, have obvious significance in checking and confirming the class of actual targets and, lastly, lower the rate of false alarms.

Expert System. Positions and classification of faults can be obtained from the steps referenced hereinabove. However, if not supplemented by the fault judgment logic in real operation scenarios, the fault inspection results may not meet the requirements of fault detection operations. Comprehensive optimization is needed using the fault judgment rules in real operation scenarios. Fault judgment conditions should be adjusted so that the faults conform to actual operation logic. In practices of the present invention, the post-processing system of the expert system includes, but is not limited to, analysis and processing based on statistical characteristics, vision-based matching algorithm, and time series processing based on time-frequency domain tests.

Among the post-processing systems in the expert system according to the present invention, processing based on statistical characteristics analysis does the following. The original ultrasonic fault detection signal may be seen as a time series denoted as:

X=((x₀,y₀,z₀),(x₁,y₁,z₁), . . . ,(xₙ,yₙ,zₙ)),

where xᵢ, yᵢ, zᵢ represent the pulse position, depth position, and ultrasonic channel information at time instance i, respectively. According to practices of the invention, analysis based on the statistical characteristics can comprise analysis performed on the original ultrasonic fault detection signals.

In the process of collecting ultrasonic rail signals, multiple factors, including the influence of the environment, vibration of hardware, operating habits, and other factors, lead to an inevitable amount of noise in the original ultrasonic fault detection data. This noise is sometimes not completely distinguishable from the fixed, useful intended targets in the rail. It is typically difficult for vision-based inspection models, such as target inspection, to avoid the influence of noise on the basis of image data. This results in a large number of cases in which noise is misjudged as either a fault or a useful target. To minimize or eliminate the effect of this situation, embodiments of the system 100 use an average envelope method to determine the noise. In synergy with the inspection results obtained, further optimization is thus realized.

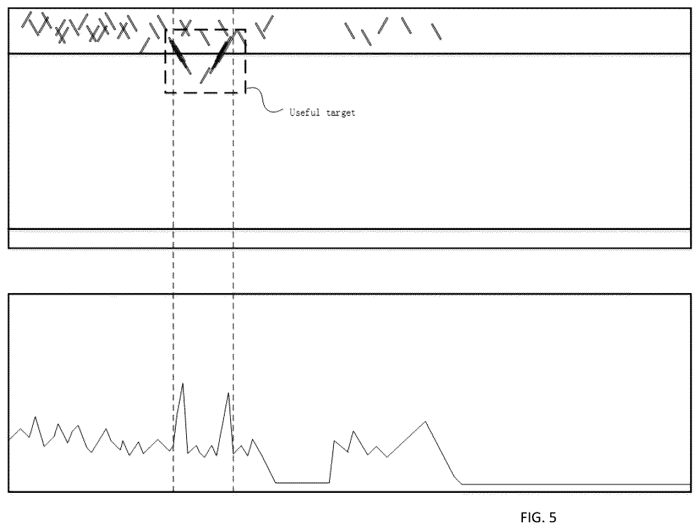

Detailed steps according to practices of the invention are as follows. According to the different positions of the channel echo waves, the time series X can be divided into head, web, foot, side channels, and potentially other aspects. There are numerous standard ways to segment the time series. Another approach contemplated according to the present invention is to divide the time series to make the echo signal in every channel a time series. For example, FIG. 5 shows the rail head echo signal visualized using B-scan data 122. As shown in the head channel time series, the changes in wave peaks corresponding to the useful target can be easily seen in the dashed box.

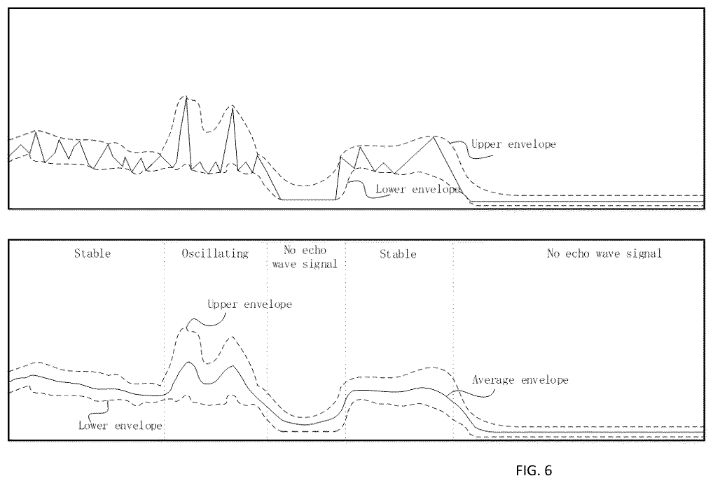

The difference between the waveforms of useful targets and noise can be easily observed using the line chart of the time series. Because the echo waves of normal targets and faults are usually aggregated, the parts for useful targets in the time series are groups of echo wave points showing certain trends and shapes. To determine the existence of sporadic random noise, a method of averaging the envelope lines is used. Upper and lower envelope lines are shown in FIG. 6.

An envelope of a family of curves is defined as the curve that is tangent to at least one point of every line in the family. In this respect, one may have further reference to Wu T H, Wang T W, Liu Y Q. Real-time vehicle and distance detection based on improved yolo v5 network[C]//2021 3rd World Symposium on Artificial Intelligence (WSAI). IEEE, 2021: 24-28., which is incorporated by reference in its entirety

A family of curves is an infinite set of curves that have some specific, predetermined relationship. The family of curves is usually in the form of F(p, q, k)=0, where p and q are the horizontal and vertical axes, respectively, and k is the parameter of the family. The following set of equations holds for determining the necessary and sufficient conditions for the envelope:

F(p,q,k)=0

Fₖ′(p,q,k)=0,

where Fₖ′(*) stands for partial derivative with respect to k.

$$\begin{matrix}\frac{\partial f}{\partial p} & \frac{\partial f}{\partial q} \\ \frac{\partial {f}_{k}^{′}}{\partial p} & \frac{\partial {f}_{k}^{′}}{\partial q}\end{matrix} \neq 0.$$

$$\frac{{\partial }^{2} f}{\partial {k}^{2}} \neq 0 .$$

After the upper and lower envelopes are determined, the average of their values in the vertical axis forms an average envelope. The noise determination method based on the average envelope is to check after targets are boxed out among noise. Thus, observation thresholds before and after the pulse position or kilometer marker decided by the target box are determined. In practices of the present invention, a threshold range of about 100 pulses before and after a joint is set, and the variance of the average envelope is calculated.

A small variance indicates that the echo wave is stable in the range of the selected channel and thus is noise or, otherwise, is a useful target. The threshold value for this variance may be adjusted according to the actual application scenario.

In addition to the determination of noise inside the ultrasonic fault detection signal using the average envelope, the system 100 also uses differential verification to monitor the targets on which the model is unable to make accurate judgment due to limits in its capabilities. The steps and example cases are as follows.

In theory, the status of either curved or straight rails can be completely collected. Due to manufacturing standards and production processes, straight rails usually have fixed lengths. Thus, the echo waves produced in relation to such rails are usually periodic to some extent. For example, the distance between welding seams and joints is always the same.

Let δ be the period of the periodic echo waves and X=((x₀, y₀, c₀), (x₁, y₁, c₁), . . . , (xₙ, yₙ, cₙ)) be the original signal. Then, the signal after one period is

$${X}_{δ} = ( ( {x}_{0} - δ , {y}_{0} , {c}_{0} ) ( {x}_{1} - δ , {y}_{1} , {c}_{1} ) , … , ( {x}_{n} - δ , {y}_{n} , {c}_{n} ) ) , and$$

$${X}_{m δ} = ( ( {x}_{0} - m \cdot δ , {y}_{0} , {c}_{0} ) , ( {x}_{1} - m \cdot δ , {y}_{1} , {c}_{1} ) , … , ( {x}_{n} - m \cdot δ , {y}_{n} , {c}_{n} ) )$$

is the signal after m periods.

Special events happening in one period can be discovered using the difference signal X-X_{δ}. Based on this, the possible mistakes at every critical point can be discovered and corrected. In the meantime, the existence of other echo waves can be discovered. Special waves after deleting the periodic targets can be monitored. The value of δ can be determined by the periodicity of the signal or autonomously chosen depending on the application scenario.

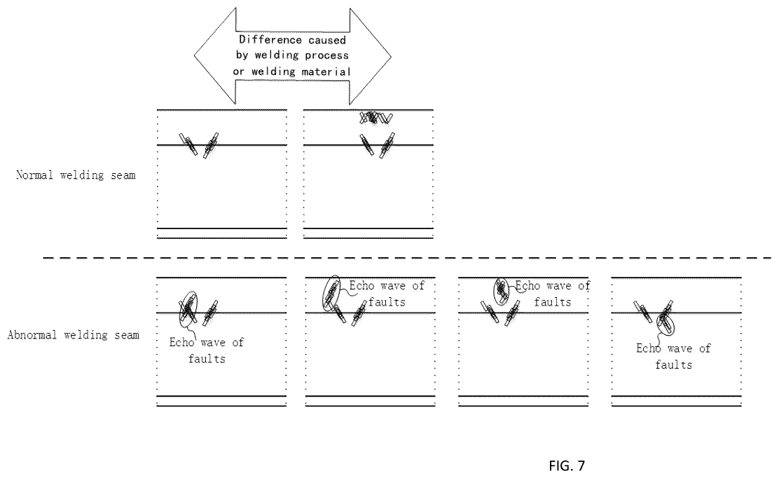

Aspects of this invention correct and verify the inspection results obtained from the depth model using a vision-based template strong matching method. Take the welding seam as an example, the manifestation of the seam is a V-shaped echo wave on the rail jaw line. The distance between the rail head channel echo waves in both directions from the seam is relatively fixed. However, because of different welding processes and materials, there may exist clutter waves from a normal welding seam, causing difficulties in verification. When there are anomalies in the welding seam, there could be nuclear injuries inside the seam or welding material or a separation of welding material from the rail body at the welding rib. The shapes of echo waves of normal and abnormal welding seams are shown in FIG. 7.

To obtain accurate fault inspection results, practices of the invention use normal targets to make templates for matching. One may obtain a deeper background understanding of such a practice by reference, for instance, to U.S. Patent Application Publication No. US20210286187A1 of Holger Müller, published Sep. 16, 2021, for a Method of Adjusting an Image Mask, which is hereby incorporated by reference in its entirety.

The template for every type of fault may be different. The most discriminating template needs to be found according to the features of the echo waves. The welding seams referenced above may again be taken as an example. As shown in FIG. 7, the echo wave patterns of the normal welding seams have a contained relationship, and the positions of the fault echo waves are different. According to the present invention, the templates may be divided into upper and lower parts for verification. The upper part of the template, which may be considered verification 1, is the V-shaped echo wave pattern on the rail jaw line and the lower part, which may be considered verification 2, is the rail surface echo wave pattern caused by differences in welding processes and materials. As shown in the lower figures in FIG. 7, the echo wave patterns of the faults are clearly seen after template strong matching. The shapes of the targets and classes of faults can thus be confirmed.

In post-processing performed by the expert system 100, noise in the original ultrasonic time series signal is removed by operation of time-frequency domain examination. The distribution of the noise is determined by means of time-frequency transformation using wavelet transform on the time series. In this respect, one may have reference to Daubechies, I. (1990). The wavelet transform, time-frequency localization and signal analysis. IEEE Transactions on Information Theory, 36(5), 961-1005, which is hereby incorporated by reference in its entirety.

The steps for the foregoing may be described as follows. Compared with short-time Fourier transformation (STFT), wavelet transform uses adaptive window sizes instead of fixed ones to provide a “time-frequency” window that can change with frequency. The wavelet transform of f(t) is defined as:

$$ω ( a , b ) = \frac{1}{√ a} \cdot {\int }_{- ∞}^{+ ∞} f ( t ) \cdot Ψ ( \frac{t - b}{a} ) dt \qquad ( 5 )$$

where ω indicates transformation into the frequency domain, a is the scaling factor used to compress or stretch the wavelet, b is the time shift factor used to translate the wavelet in time, and ψ(*) is the kernel function.

Since the ultrasonic rail data is a discrete time series, discrete wavelet transform having discrete scaling and shift factors is used. The wavelet transform largely compensates for the shortcomings of Fourier decomposition in non-stationary time series and, by replacing the sine and cosine waves of Fourier decomposition with a set of attenuating orthogonal bases, the abrupt and non-stationary parts in the time series can be well expressed.

A core function of the wavelet transform is to use filters of different frequencies to analyze signals of different frequencies. The steps to apply discrete wavelet transform may include the following:
(1) Pass the signal X through a high-pass filter with impulse response h(n) to filter out frequency contents lower than P/2 where P is the highest frequency of the signal. This is called half-bandwidth high-pass filtering.
(2) Sample the signal using Nyquist rate and delete samples at a certain time interval. Half of the samples of the original signal are left. Increase the scaling factor and high-pass filter this remaining half again.
(3) Divide the resulting signal from the high-pass filter into two halves and pass them through both high-pass and low-pass filters.
(4) Repeat the above steps and adjust according to the actual situation.

Under the foregoing process, position information is preserved. Through wavelet transform, noise of different scales can be avoided using the adaptive window sizes.

Embodiments of the system 100 and method may utilize multimodal fusion to inspect for faults-in-rail. Multimodal fusion makes use of ultrasonic rail data, B-scan image data 122 and high-definition rail surface image data captured by line scan cameras. These three types of data have their own respective advantages and characteristics. Although their structure, features, dimensionality and expression are different, they all are closely related to faults-in-rail. Through combined analysis and processing, a comprehensive and complete presentation of the faults-in-rail is realized.

Different models may be used to process the different modal data. The R-DETR and YOLO models have their own strengths in the selection of and adaptation to target size and real visual features of the data. The use of multimodal processing on different data avoids possible missed faults as could occur when one single model is used alone and thus prevents the occurrence of severe accidents in the rail system. R-DETR is a specially designed model aimed at the inspection and classification of the internal faults in the rail. Compared with ordinary DETR, R-DETR adjusts and optimizes the network structure to cut model size and accelerate computation. In the meantime, the use of Feature Pyramid Transformer Network (“FPN”) improves accuracy on small targets after the model size is reduced.

This includes the use of a more lightweight backbone network and adjustment made to the feed forward network (FFN) module inside the transformer structure. Because of the symmetrical structure existing in the echo waves of screw holes, welding seams, and joints, the fine-grained image classification model Rail-CNN (R-CNN) is designed specifically for targets with symmetry.

A rich and well-defined expert system 100 is thus created pursuant to practices of the present invention. The system 100 double checks the inspection results from the models described herein using time series analysis, frequency-domain analysis, and vision-based strong matching techniques. It can fuse fault recognition results from different modalities and combine them with each other for fault analysis. It also quantifies real-world fault detection experiences summarized by fault detection personnel and applies them in the intelligent recognition system 100, making the fault inspection results closely comply with the actual operation scenarios.

Multi-level inspection is adopted by embodiments of the invention. Using a combination of B-scan image data 122 and high-definition rail surface image data avoids the expansion of severe faults to the surface to a great extent, allowing immediate inspection of these faults, and providing specialized guidance for the follow-up maintenance operations. The expert system focuses mainly on internal faults, and the combined processing of different modal data optimizes the initial fault inspection results.

The foregoing descriptions have been presented for the purposes of illustration and description. They are not exhaustive and do not limit the invention to the precise form disclosed. Modifications and variations are possible in light of the teachings provided herein or may be acquired from practicing the disclosed invention. For example, implementation of the invention may include methods and systems implemented as software, but the present invention may be implemented as a combination of hardware and software or in hardware alone. Additionally, although aspects of the present invention are described as being stored in memory, one skilled in the art will appreciate that these aspects can also be stored on other types of computer-readable media, such as secondary storage devices, like hard disks, floppy disks, or CD-ROM; a carrier wave from the Internet or other propagation medium; or other forms of RAM, ROM, or any other storage method or apparatus.

With certain details and embodiments of the present invention for systems and methods for intelligent fault-in-rail analysis disclosed, it will be appreciated by one skilled in the art that numerous changes and additions could be made thereto without deviating from the spirit or scope of the invention. This is particularly true when one bears in mind that the presently preferred embodiments merely exemplify the broader invention revealed herein. Accordingly, it will be clear that those with major features of the invention in mind could craft embodiments that incorporate those major features while not incorporating all of the features included in the preferred embodiments.

Therefore, the following claims shall define the scope of protection to be afforded to the invention. Those claims shall be deemed to include equivalent constructions insofar as they do not depart from the spirit and scope of the invention. It must be further noted that a plurality of the following claims may express, or be interpreted to express, certain elements as means for performing a specific function, at times without the recital of structure or material. As the law demands, any such claims shall be construed to cover not only the corresponding structure and material expressly described in this specification but also all legally-cognizable equivalents thereof.

The following is claimed as deserving the protection of Letters Patent:

1. A method for fault-in-rail analysis based on multimodal data to determine rail line faults, the method comprising:
acquiring optical images of a rail surface to produce optical rail data;
acquiring sonic based rail data;
computing image data of the rail from the acquired sonic based rail data;
correlating the optical rail data and the sonic based rail data; and
using the optical rail data and the sonic based rail data to determine the rail line faults.

2. The method of claim 1, wherein the rail line faults are determined by an expert system.

3. The method of claim 1, wherein the sonic based rail data is preprocessed.

4. The method of claim 1, wherein the detected rail line faults are classified.

5. The method of claim 1, wherein the rail line faults are detected by use of an R-DETR or YOLO inspection algorithm.

6. A system for fault-in-rail analysis based on multimodal data to determine rail line faults, the system comprising:
a first sensor for acquiring optical images of a rail surface of a rail line to produce optical rail data;
a second sensor for acquiring sonic based rail data;
an electronic computing apparatus for computing image data of the rail from the acquired sonic based rail data;
wherein the computing apparatus correlates the optical rail data and the sonic based rail data and wherein the computing apparatus uses the optical rail data and the sonic based rail data to determine rail line faults.

7. The system of claim 6, wherein the rail line faults are determined by an expert system.

8. The system of claim 6, wherein the sonic based rail data is preprocessed.

9. The system of claim 6, wherein the detected rail line faults are classified.

10. The system of claim 6, wherein the rail line faults are detected by use of an R-DETR or YOLO inspection algorithm.
